(19) United States
(12) Patent Application Publication
(10) Pub. No.: US 2025/0299689 A1
(43) Pub. Date: Sep. 25, 2025

(54) METHOD AND SYSTEM FOR CONTROLLING SOUND OUTPUT IN VEHICLE

(71) Applicants: Hyundai Motor Company, Seoul (KR); Kia Corporation, Seoul (KR)

(72) Inventor: Sun Kyung KIM, Seongnam-Si (KR)

(73) Assignees: Hyundai Motor Company, Seoul (KR); Kia Corporation, Seoul (KR)

(21) Appl. No.: 18/946,123

(22) Filed: Nov. 13, 2024

(30) Foreign Application Priority Data
Mar. 19, 2024 (KR) 10-2024-0037994

(51) Int. Cl. G10L 21/0272

(52) U.S. Cl. CPC G10L 21/0272

(57) ABSTRACT

In method and system for controlling a sound output in a vehicle, the method of controlling a sound output includes outputting a first sound signal corresponding to an occupant's voice input from a microphone and a second sound signal corresponding to a media sound through a sound output device at a first occasion, receiving, through the microphone, at a second occasion elapsed by a time offset from the first occasion, a mixed signal in which the first sound signal and the second sound signal output through the sound output device at the first occasion, and a third sound signal corresponding to the occupant's voice are mixed, and removing, by an infotainment controller, the second sound signal from the mixed signal, and reducing the first sound signal to generate a first output signal.

### CROSS-REFERENCE TO RELATED APPLICATION

The present application claims priority to Korean Patent Application No. 10-2024-0037994 filed on Mar. 19, 2024, the entire contents of which is incorporated herein for all purposes by this reference.

### BACKGROUND OF THE PRESENT DISCLOSURE

### Field of the Present Disclosure

The present disclosure relates to a method and system for controlling a sound output, and more particularly to a method and system for controlling an output of a voice signal and a media signal input from a microphone in a vehicle.

### Description of Related Art

Recently, with the car culture becoming commonplace according to the improvement of living standards, the time when passengers stay inside the car is gradually increasing due to long-distance driving such as traveling, traffic jams, and the like. Accordingly, various kinds of amenities and convenience services are being provided inside the vehicle for the convenience of passengers who stay inside the vehicle for a long time period.

Representatively, there is a telematics service among these convenience services. The telematics is a term that combines telecommunication and informatics, and is defined as a next-generation information provision service for automobiles through the combination of the IT industry and the automobile industry, where wireless communication, automobiles, terminals, contents, and the like are organically related to each other.

Conventional telematics services may provide traffic and traveling information, emergency response information, remote vehicle diagnostic services, and various services such as the Internet, electronic mail (e-mail), life information, entertainment, and the like through in-vehicle terminals using wireless communication technology and satellite global positioning system (GPS) technology.

Furthermore, there is a trend to expand into integrated vehicle platforms that offer content such as music and radio while traveling, as contents which may be consumed while traveling is varied.

However, conventional in-vehicle content delivery technologies have the disadvantage of not being able to use conversational functions between a driver and a passenger using in-vehicle microphones and speakers to enable while providing sound-based contents such as music and radio when driving. Furthermore, the performance limitations of the chip responsible for media processing did not allow the use of a plurality of separate channels.

Therefore, there is a need for a sound output control technology configured for enabling a conversation between a driver and a passenger while providing sound-based contents in a vehicle, and of using a plurality of separate channels.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method and system for controlling a sound output that enables a conversation between a driver and a passenger while providing sound-based content within a vehicle.

The present disclosure has also been made in an effort to provide a method and system for controlling a sound output which is configured for using a plurality of channels.

Technical problems to be solved by the present disclosure are not limited to the above-mentioned technical problems, and other technical problems, which are not mentioned above, may be clearly understood from the following descriptions by those skilled in the art to which the present disclosure pertains.

To achieve the aforementioned objects, there is provided a method of controlling a sound output according to an exemplary embodiment of the present disclosure, the method including: outputting a first sound signal corresponding to an occupant's voice input from a microphone and a second sound signal corresponding to a media sound through a sound output device at a first occasion; receiving, through the microphone, at a second occasion elapsed by a time offset from the first occasion, a mixed signal in which the first sound signal and the second sound signal output through the sound output device at the first occasion, and a third sound signal corresponding to the occupant's voice are mixed; and removing, by an infotainment controller, the second sound signal from the mixed signal, and reducing the first sound signal to generate a first output signal.

In the instant case, the method may further include: generating a second output signal corresponding to the media sound of the second occasion; and transmitting, to the sound output controller, a control signal including assignment information on the sound output device to output the first and second output signals and information on loudness of the first and second output signals output from each sound output device.

In the instant case, the first and second output signals, and the control signal, may be each transmitted through different channels.

In the instant case, the first output signal may be transmitted to the sound output controller through a first data channel, the second output signal may be transmitted to the sound output controller through a second data channel, and the control signal may be transmitted to the sound output controller through a control channel, respectively.

In the instant case, the first and second data channels may be channels using an automotive audio bus (A2B) method.

In the instant case, the control channel may be a channel using a Controller Area Network (CAN) method.

In the instant case, the first and second data channels may be channels using a communication of the Sony/Philips Digital Interface (S/PDIF) specification or an analog communication method.

In the instant case, the control channel may be a channel using an Ethernet communication method.

In the instant case, the time offset may be determined by a time difference in which a signal input from the microphone is received by the sound output device.

In the instant case, the method may further include: receiving a feedback signal from the sound output controller, in which in the generating of the first output signal, the second sound signal may be removed based on a feedback signal received from the sound output controller.

Meanwhile, there is provided a system for controlling a sound output according to an exemplary embodiment of the present disclosure, the system including: a sound output controller configured to output, at a first occasion, a first sound signal corresponding to an occupant's voice input from a microphone and a second sound signal corresponding to a media sound; a microphone configured to receive, at a second occasion elapsed by a time offset from the first occasion, a mixed signal in which the first sound signal and the second sound signal output through the sound output device at the first occasion, and a third sound signal corresponding to the occupant's voice are mixed; and an infotainment controller configured to remove the second sound signal from the mixed signal, and to reduce the first sound signal to generate a first output signal.

In the instant case, the infotainment controller may further configured to generate a second output signal corresponding to the media sound of the second occasion and transmit, to the sound output controller, a control signal including assignment information on the sound output device to output the first and second output signals and information on loudness of the first and second output signals output from each sound output device.

In the instant case, the first and second output signals, and the control signal, may be each transmitted through different channels.

In the instant case, the first output signal may be transmitted to the sound output controller through a first data channel, the second output signal may be transmitted to the sound output controller through a second data channel, and the control signal may be transmitted to the sound output controller through a control channel, respectively.

In the instant case, the first and second data channels may be channels using an automotive audio bus (A2B) method.

In the instant case, the control channel may be a channel using a Controller Area Network (CAN) method.

In the instant case, the first and second data channels may be channels using a communication of the Sony/Philips Digital Interface (S/PDIF) specification or an analog communication method.

In the instant case, the control channel may be a channel using an Ethernet communication method.

In the instant case, the time offset may be determined by a time difference in which a signal input from the microphone is received by the sound output device.

In the instant case, the infotainment controller is configured to receive a feedback signal from the sound output controller, and the second sound signal may be removed based on the signal received from the sound output controller.

According to the various embodiments of the present disclosure as described above, a conversation between a driver and a passenger is possible while providing sound-based content in a vehicle.

Furthermore, there is provided a method and system for controlling a sound output in which a plurality of channels may be used on a single chip.

The effects obtained by the present disclosure are not limited to the aforementioned effects, and other effects, which are not mentioned above, will be clearly understood by those skilled in the art from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram schematically illustrating a system for controlling a sound output according to an exemplary embodiment of the present disclosure.

FIG. 2 is a block diagram illustrating the system for controlling a sound output in FIG. 1.

FIG. 3 is a flowchart illustrating a method of controlling a sound output according to an exemplary embodiment of the present disclosure.

FIG. 4 illustrates a computer system according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably to facilitate the description, but the suffixes themselves do not have distinguishable meanings or functions. Furthermore, in the description of the exemplary embodiment included in the present specification, the specific descriptions of publicly known related technologies will be omitted when it is determined that the specific descriptions may obscure the subject matter of the exemplary embodiment included in the present specification. Furthermore, it should be interpreted that the accompanying drawings are provided only to allow those skilled in the art to easily understand the exemplary embodiments included in the present specification, and the technical spirit included in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

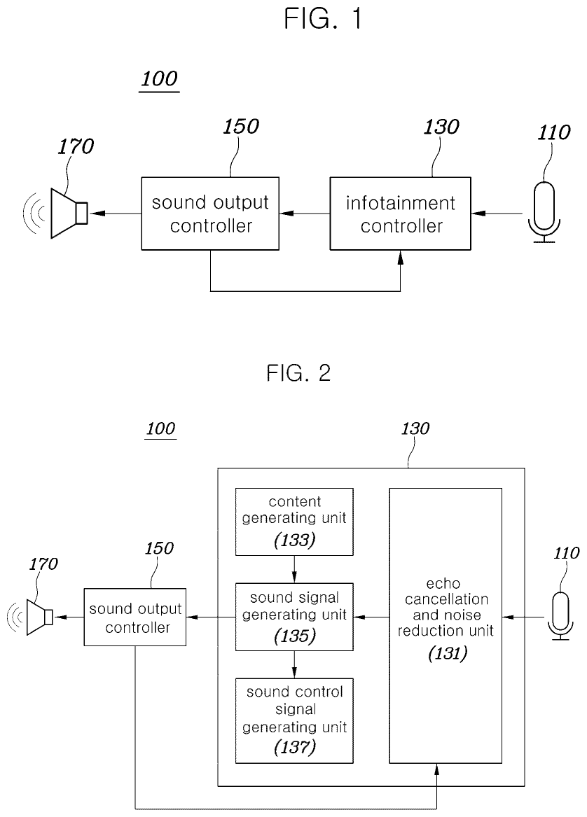

FIG. 1 is a block diagram schematically illustrating a system for controlling a sound output according to an exemplary embodiment of the present disclosure.

With reference to FIG. 1, a system 100 for controlling a sound output according to the exemplary embodiment includes a microphone 110, an infotainment controller 130 operatively connected to the microphone 110, a sound output controller 150 operatively connected to the infotainment controller 130, and a speaker 170 operatively connected to the sound output controller 150.

The microphone 110 is provided within a vehicle to receive a sound signal as input thereof from the vehicle.

In the instant case, the microphone 110 may receive the sound signal as input thereof from the vehicle either periodically or continuously, or frequently by a user's input.

The infotainment controller 130 transmits the sound signal input from the microphone 110, a sound signal generated based on content for occupants of the vehicle, and a control signal for controlling an output thereof to the sound output controller 150.

In the instant case, the infotainment controller 130 may be provided in a form of a single chipset or an integrated module that combines a single chipset and software, for example, as a connected car Navigation Cockpit (ccNC) chip or ccNC module.

Furthermore, the infotainment controller 130 may be one of a plurality of controllers for the control of the vehicle.

In the instant case, the sound signal generated based on the content for the occupants of the vehicle may be music, radio, navigation guidance voice, and the like.

In the instant case, the sound signal and the control signal transmitted from the infotainment controller 130 to the sound output controller 150 may be transmitted through different channels.

In the instant case, the infotainment controller 130 may transmit the sound signal generated based on the sound signal input from the microphone 110 and the content for the occupants of the vehicle to the sound output controller 150 through a data channel, and for example, the data channel may be an automotive audio bus (A2B) communication channel.

Furthermore, the sound signal may be transmitted to the sound output controller 150 through a communication of the Sony/Philips Digital Interface (S/PDIF) specification or an analog voice channel.

Furthermore, the infotainment controller 130 may transmit a control signal that controls an output on sound to the sound output controller 150 through a control channel, and for example, the control channel may be a Controller Area Network (CAN) communication channel.

Furthermore, the control signal may be transmitted to the sound output controller 150 through the Ethernet communication.

The sound output controller 150 receives a sound signal and a control signal for the control of the speaker from the infotainment controller 130, and outputs the sound signal through the speaker.

Furthermore, the sound output controller 150 may transmit a feedback signal on the sound signal received from the infotainment controller 130 through a data channel, and for example, the data channel may be an automotive audio bus (A2B) communication channel.

The feedback signal is determined by the sound output controller 150 based on various parameters related to the audio signal it processes.

The speaker 170 outputs the sound signal received from the sound output controller 150 into the vehicle.

Meanwhile, in the present specification, the term “speaker” may be used interchangeably with a “sound output device”.

In the instant case, the speaker 170 may be at least one speaker, and may be a sound device, such as a wired speaker and a wireless speaker.

In the instant case, the sound signal means an auditory signal that includes both sound signals and non-sound signals.

FIG. 2 is a block diagram illustrating the system for controlling a sound output in FIG. 1.

With reference to FIG. 2, the system 100 for controlling a sound output includes the microphone 110, the infotainment controller 130, the sound output controller 150, and the speaker 170.

The microphone 110 is provided within the vehicle, and receives a sound signal within the vehicle as input thereof and transmits the sound signal to an echo cancellation and noise reduction unit 131.

In the instant case, the microphone 110 may transmit the sound signal within the vehicle to the echo cancellation and noise reduction unit 131 periodically, continuously, or for a time set by the user's input.

In the instant case, the microphone 110 receives, at a second occasion elapsed by a time offset from the first occasion, a mixed signal in which a first sound signal output through the speaker at the first occasion and a second sound signal, and a third sound signal corresponding to an occupant's voice are mixed.

In the instant case, the time offset Δt may be determined based on a time difference in which a signal input from the microphone 110 is received by the speaker 170.

Furthermore, noises coming from the interior or exterior of the vehicle may be input to the microphone 110.

The infotainment controller 130 transmits a media sound generated based on the sound signal input from the microphone 110 and the content for the occupants of the vehicle to the sound output controller 150.

With reference to FIG. 2, the infotainment controller 130 includes the echo cancellation and noise reduction unit 131, a content generating unit 133, a sound signal generating unit 135, and a sound control signal generating unit 137.

The echo cancellation and noise reduction unit 131 removes the second sound signal from the mixed signal received through the microphone 110, and transmits the first output signal generated by reducing the first sound signal and noise to the sound signal generation unit 135.

In the instant case, the first occasion means an occasion that precedes the current occasion by a delay time until the signal input from the microphone 110 is output through the speaker 170.

In the instant case, the echo cancellation and noise reduction unit 131 may be provided in a form of a single chipset or an integrated module that combines a single chipset and software, for example, as an echo cancellation noise reduction (ECNR) chip or ECNR module.

In the instant case, the second sound signal may be removed based on a feedback signal received from the sound output controller 150.

Meanwhile, the echo cancellation and noise reduction unit 131 may use a plurality of channels on a single chip.

The content generating unit 133 generates and transmits the second output signal corresponding to the media sound based on the content for the occupants of the vehicle to the sound signal generating unit 135.

In the instant case, the content generating unit 133 may be provided in a form of a single chipset or an integrated module that combines a single chipset and software, for example, as an application processor (AP) chip or AP module.

In the instant case, the media sound based on the content for the occupants of the vehicle may be music, radio, navigation guidance voice, and the like.

The sound signal generating unit 135 transmits the first output signal received from the echo cancellation and noise reduction unit 131 and the second output signal received from the content generating unit 133 to the sound output controller 150.

In the instant case, the sound signal generating unit 135 may be provided in a form of a single chipset or an integrated module that combines a single chipset and software, for example, as a digital signal processor (DSP) chip or DSP module.

In the instant case, the filtered microphone input signal and the second sound signal of the current occasion may be transmitted to the sound output controller 150 in different channels.

In the instant case, a channel over which the filtered microphone input signal is transmitted may be defined as a first data channel, and a channel over which the second sound signal of the current occasion is transmitted may be defined as a second data channel.

In the instant case, the sound signals transmitted from the sound signal generating unit 135 to the sound output controller 150 may be transmitted through a data channel, and for example, the data channel may be a channel using an automotive audio bus (A2B) method.

Furthermore, the sound signals may be transmitted to the sound output controller 150 through a communication of the Sony/Philips Digital Interface (S/PDIF) specification or an analog voice channel.

The sound control signal generating unit 137 transmits a control signal for the control of the output of the first and second output signals output through the speaker 170 to the sound output controller 150.

In the instant case, the sound control signal generating unit 137 may be provided in a form of a single chipset or an integrated module that combines a single chipset and software, for example, as a microprocessor chip or microprocessor module.

Furthermore, the sound control signal generating unit 137 may be provided as a micom controller.

In the instant case, the control signal transmitted from the sound signal generating unit 135 to the sound output controller 150 may be transmitted through a control channel, and for example, the control channel may be a channel using a Controller Area Network (CAN) method.

Furthermore, the control signal may be transmitted to the sound output controller 150 through the Ethernet communication.

In the instant case, the control signal transmitted from the sound control signal generating unit 137 to the sound output controller 150 may include assignment information on the speakers to output the first and second output signals and information on the loudness of the first and second output signals output from each speaker.

Here, the assignment information refers to the details about which speakers are designated to output the first and second audio signals.

The sound output controller 150 is configured to control the speaker 170 based on the first and second output signals received from the sound signal generating unit 135 and the control signal received from the sound control signal generating unit 137.

Furthermore, the sound output controller 150 transmits a feedback signal on the sound signal received from the sound signal generating unit 135 at the first occasion to the echo cancellation and noise reduction unit 131.

In the instant case, the sound output controller 150 may transmit the feedback signal through a data channel, for example, the data channel may be an automotive audio bus (A2B) communication channel.

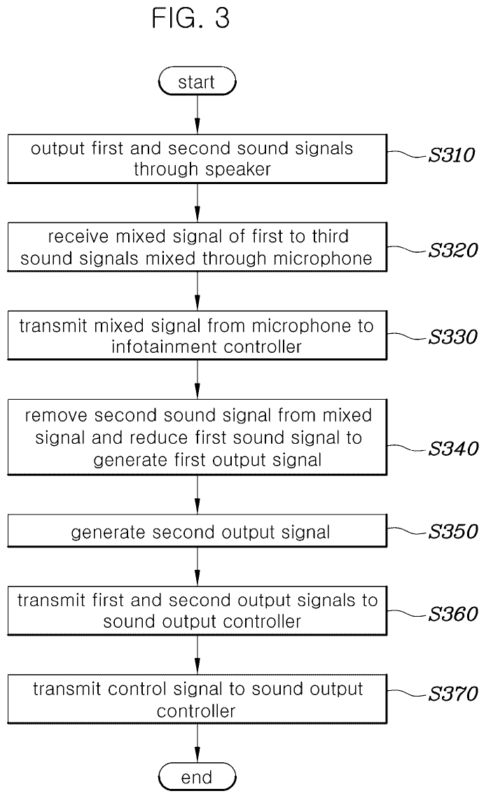

FIG. 3 is a flowchart illustrating a method of controlling a sound output according to an exemplary embodiment of the present disclosure.

The method of controlling a sound output according to the exemplary embodiment may be performed by the system 100 for controlling a sound output according to the exemplary embodiment of FIG. 1 or FIG. 2.

With reference to FIG. 3, the speaker 170 outputs the first sound signal corresponding to an occupant's voice input from the microphone at the first occasion and the second sound signal corresponding to the media sound (S310).

In the instant case, the speaker 170 may output a sound signal that further includes noise.

In the instant case, the first occasion means an occasion that precedes the current occasion by a time offset until the signal input from the microphone 110 is output through the speaker 170.

Furthermore, the microphone 110 receives, at the second occasion elapsed by a time offset from the first occasion, a mixed signal in which the first sound signal output through the speaker at the first occasion and the second sound signal, and the third sound signal corresponding to an occupant's voice are mixed (S320).

In the instant case, although not illustrated in the drawings, the sound output controller 150 transmits, at the second occasion, a feedback signal on the sound signal received from the sound signal generating unit 135 at the first occasion to the infotainment controller 130.

In the instant case, the mixed signal may further include noise.

Furthermore, the microphone 110 transmits the mixed signal to the infotainment controller 130 (S330).

Furthermore, the infotainment controller 130 removes the second sound signal from the mixed signal, and reduces the first sound signal to generate a first output signal (S340).

In the instant case, the second sound signal may be removed based on the feedback signal received from the sound output controller 150.

In the instant case, the infotainment controller 130 may be configured to generate the first output signal by further reducing noise from the mixed signal.

Furthermore, the infotainment controller 130 generates a second output signal corresponding to the media sound of the second occasion (S350).

In the instant case, the media sound may be a media sound based on the content for the occupants of the vehicle, and may be music, radio, navigation guidance voice, and the like.

Furthermore, the infotainment controller 130 transmits the first output signal generated in step S340 and the second output signal generated in step S350 to the sound output controller 150 (S360).

In the instant case, the first output signal and the second output signal may be transmitted to the sound output controller 150 in different data channels.

In the instant case, a channel over which the first output signal is transmitted may be defined as a first data channel, and a data channel over which the second output signal is transmitted may be defined as a second data channel.

In the instant case, the first and second data channels, for example, the data channel may be an automotive audio bus (A2B) communication channel.

Furthermore, the first and second data channels may be channels using a communication of the Sony/Philips Digital Interface (S/PDIF) specification or an analog communication method.

Furthermore, the infotainment controller 130 transmits a control signal for the control of the speaker 170 to the sound output controller 150 (S370).

In the instant case, the control signal may be transmitted through a control channel, and for example, the control channel may be a Controller Area Network (CAN) communication channel.

Furthermore, the control channel may be a channel using an Ethernet communication method.

In the instant case, the control signal may include assignment information on the speakers to output the first and second output signals and information on the loudness of the first and second output signals output from each speaker.

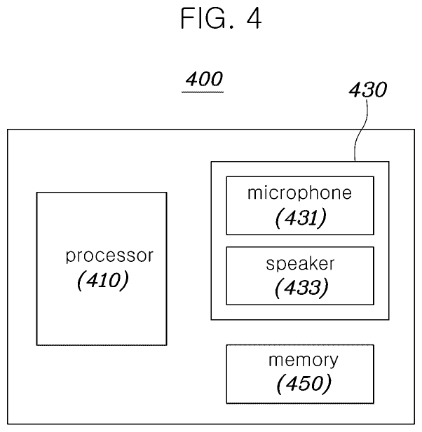

FIG. 4 illustrates a computer system according to an exemplary embodiment of the present disclosure.

With reference to FIG. 4, the exemplary embodiments of the present disclosure may be implemented in a computer system, such as a computer-readable recording medium. As illustrated in FIG. 4, a computer system 400 includes a processor 410, an input/output unit 430, and a memory 450.

The processor 410 implements the method of controlling a sound output provided in the present specification. The processor 410 implements all of the operations of the infotainment controller and the sound output controller in the exemplary embodiments included in the present specification, and is configured to perform all of the operations of the method of controlling a sound output according to FIG. 3.

For example, the processor 410 receives, at the second occasion elapsed by a time offset from the first occasion, from the microphone 431, a mixed signal in which the first sound signal output through the speaker at the first occasion and the second sound signal, and the third sound signal corresponding to an occupant's voice are mixed.

In the instant case, the mixed signal may further include noise.

Furthermore, the processor 410 removes the second sound signal from the mixed signal, and reduces the first sound signal to generate a first output signal.

In the instant case, the processor 410 may be configured to generate the first output signal by further reducing noise from the mixed signal.

Furthermore, the processor 410 generates the second output signal corresponding to the media sound of the second occasion.

In the instant case, the media sound may be a media sound based on the content for the occupants of the vehicle, and may be music, radio, navigation guidance voice, and the like.

The input/output unit 430 is connected to the processor 410 to directly obtain information from the outside thereof, or to output information to the outside thereof.

The input/output unit 430 includes a microphone 431 and a speaker 433.

The microphone 431 receives, at the second occasion elapsed by a time offset from the first occasion, a mixed signal in which the first sound signal output through the speaker at the first occasion and the second sound signal, and the third sound signal corresponding to an occupant's voice are mixed.

In the instant case, the first occasion may be an occasion in which the first sound signal corresponding to an occupant's voice input from the microphone and the second sound signal corresponding to a media sound are output through the speaker.

The speaker 433 outputs the first sound signal corresponding to an occupant's voice input from the microphone at the first occasion and the second sound signal corresponding to the media sound.

In the instant case, the speaker 170 may be at least one speaker, and may be a sound device, such as a wired speaker and a wireless speaker.

In the instant case, the sound signal means an auditory signal that includes both sound signals and non-sound signals.

The memory 450 may be various forms of volatile or non-volatile storage media. In the instant case, the memory 450 stores at least one of a mixed signal in which the first, second, and third sound signals of the first occasion are mixed, the second sound signal, the first output signal, the second output signal, the control signal for the control of the speaker 433, or a combination thereof.

According to the exemplary embodiments of the present disclosure described above, a conversation between a driver and a passenger is possible while providing sound-based content in a vehicle.

Furthermore, there is provided the method and system for controlling a sound output in which a plurality of channels may be used on a single chip.

Meanwhile, the present disclosure described above may be implemented as a computer-readable code on a medium on which a program is recorded. The computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices. Therefore, it should be appreciated that the detailed description is interpreted as being illustrative in every aspects, not restrictive. The scope of the present disclosure should be determined based on the reasonable interpretation of the appended claims, and all of the modifications within the equivalent scope of the present disclosure belong to the scope of the present disclosure.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operably may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of controlling a sound output in a vehicle, the method comprising:
outputting a first sound signal corresponding to an occupant's voice input from a microphone and a second sound signal corresponding to a media sound through a sound output device at a first occasion;
receiving, through the microphone, at a second occasion elapsed by a time offset from the first occasion, a mixed signal in which the first sound signal and the second sound signal output through the sound output device at the first occasion, and a third sound signal corresponding to the occupant's voice are mixed; and
removing, by an infotainment controller operatively connected to the microphone, the second sound signal from the mixed signal, and reducing the first sound signal to generate a first output signal.

2. The method of claim 1,
wherein the sound output device is in plural, and
wherein the method further includes:
generating a second output signal corresponding to the media sound of the second occasion; and
transmitting, to a sound output controller operatively connected to the infotainment controller, a control signal including assignment information on the sound output devices to output the first and second output signals and information on loudness of the first and second output signals output from each sound output device of the plurality of sound output devices.

3. The method of claim 2, wherein the first and second output signals, and the control signal, are each transmitted through different channels.

4. The method of claim 3, wherein the first output signal is transmitted to the sound output controller through a first data channel of the different channels, the second output signal is transmitted to the sound output controller through a second data channel of the different channels, and the control signal is transmitted to the sound output controller through a control channel of the different channels, respectively.

5. The method of claim 4, wherein the first and second data channels are channels using an automotive audio bus (A2B) method.

6. The method of claim 4, wherein the control channel is a channel using a Controller Area Network (CAN) method.

7. The method of claim 4, wherein the first and second data channels are channels using a communication of Sony/Philips Digital Interface (S/PDIF) specification or an analog communication method.

8. The method of claim 4, wherein the control channel is a channel using an Ethernet communication method.

9. The method of claim 1, wherein the time offset is determined by a time difference in which a signal input from the microphone is received by the sound output device.

10. The method of claim 1, further including:
receiving a feedback signal from the sound output controller,
wherein in the generating of the first output signal, the second sound signal is removed based on the feedback signal received from the sound output controller.

11. A system for controlling a sound output, the system comprising:
a sound output controller configured to output, at a first occasion, a first sound signal corresponding to an occupant's voice input from a microphone and a second sound signal corresponding to a media sound;
a microphone configured to receive, at a second occasion elapsed by a time offset from the first occasion, a mixed signal in which the first sound signal and the second sound signal output through the sound output device at the first occasion, and a third sound signal corresponding to the occupant's voice are mixed; and
an infotainment controller operatively connected to the microphone and the sound output controller and configured to remove the second sound signal from the mixed signal, and to reduce the first sound signal to generate a first output signal.

12. The system of claim 11,
wherein the sound output device is in plural, and
wherein the infotainment controller is further configured to generate a second output signal corresponding to the media sound of the second occasion and transmit, to the sound output controller, a control signal including assignment information on the sound output devices to output the first and second output signals and information on loudness of the first and second output signals output from each sound output device of the plurality of sound output devices.

13. The system of claim 12, wherein the first and second output signals, and the control signal, are each transmitted through different channels.

14. The system of claim 13, wherein the first output signal is transmitted to the sound output controller through a first data channel of the different channels, the second output signal is transmitted to the sound output controller through a second data channel of the different channels, and the control signal is transmitted to the sound output controller through a control channel of the different channels, respectively.

15. The system of claim 14, wherein the first and second data channels are channels using an automotive audio bus (A2B) method.

16. The system of claim 14, wherein the control channel is a channel using a Controller Area Network (CAN) method.

17. The system of claim 14, wherein the first and second data channels are channels using a communication of Sony/Philips Digital Interface (S/PDIF) specification or an analog communication method.

18. The system of claim 14, wherein the control channel is a channel using an Ethernet communication method.

19. The system of claim 11, wherein the time offset is determined by a time difference in which a signal input from the microphone is received by the sound output device.

20. The system of claim 11, wherein the infotainment controller is further configured to receive a feedback signal from the sound output controller, and
wherein the second sound signal is removed based on the feedback signal received from the sound output controller.
